(19) United States
(12) Patent Application Publication
(10) Pub. No.: US 2025/0046002 A1
(43) Pub. Date: Feb. 6, 2025

(54) RAY TRACING QUALITY CONTROL METHOD ACCORDING TO CAMERA MOVEMENT, RAY TRACING QUALITY CONTROL APPARATUS PERFORMING THE SAME, AND RECORDING MEDIUM STORING THE SAME

(71) Applicant: INDUSTRY ACADEMY COOPERATION FOUNDATION OF SEJONG UNIVERSITY, Seoul (KR)

(72) Inventors: Woo Chan PARK, Seoul (KR); Ji Young KIM, Seoul (KR)

(73) Assignee: INDUSTRY ACADEMY COOPERATION FOUNDATION OF SEJONG UNIVERSITY, Seoul (KR)

(21) Appl. No.: 18/718,183

(22) PCT Filed: Dec. 7, 2022
(86) PCT No.: PCT/KR2022/019839

§ 371 Date: Jun. 10, 2024

(30) Foreign Application Priority Data
Dec. 10, 2021 (KR) 10-2021-0176656

(51) Int. Cl. G06T 15/06; G06T 7/00; G06T 7/20

(52) U.S. Cl. CPC G06T 15/06; G06T 7/0002; G06T 7/20; G06T 2207/30168

(57) ABSTRACT

The present disclosure relates to a ray tracing image quality control method according to camera movement, an image quality control apparatus performing the same, and a recording medium storing the same, and the apparatus includes: an image sensitivity threshold setter configured to set an image sensitivity threshold based on a resolution of an image and a screen size; a current frame measurer configured to measure a camera movement speed through rendering of a current frame of the image; a previous frame measurer configured to measure Frame Per Second (FPS) through rendering of a previous frame of the image; an image sensitivity threshold adjuster configured to adjust the image sensitivity threshold based on the FPS and the camera movement speed; and a frame renderer configured to perform selective rendering of the current frame based on the adjusted image sensitivity threshold.

### CROSS-REFERENCE TO PRIOR APPLICATIONS

This Application is a National Stage Patent Application of PCT International Application No. PCT/KR2022/019839 (filed on Dec. 7, 2022), which claims priority to Korean Patent Application No. 10-2021-0176656 (filed on Dec. 10, 2021), which are all hereby incorporated by reference in their entirety.

### BACKGROUND

The present disclosure relates to a three-dimensional (3D) graphics processing technology, and more particularly, to a ray tracing image quality control technology according to camera movement, the technology enabling the control of ray tracing-based rendering image quality and performance based on human cognitive factors.

A 3D graphic technology is a graphic technology that uses a three-dimensional representation of geometric data stored in computing, and is widely used today in various industries including the media industry and the game industry. In general, the 3D graphic technology requires a separate high-performance graphic processor due to a large amount of computation.

Recently, with the development of processors, researches are being conducted on ray tracing technology capable of creating very realistic 3D graphics.

The ray tracing technology as a rendering scheme based on global illumination can create realistic 3D images because reflection, refraction, and shadow effects are naturally provided by considering an effect of light reflected or refracted from other objects on an image of a current object.

### PRIOR ART DOCUMENT

### Patent Document

Korean Patent Application Publication No. 10-2015-0039493 (Apr. 10, 2015)

### SUMMARY

Essentially, in static environments, human eyes have a wide field of view, while perceptiveness thereof may improve in dynamic settings. A low camera movement speed may lead to sensitivity to image quality because of slow screen transitions, while a high camera movement speed may lead to sensitivity to frame rate per second (FPS), which is the processing speed per second, because of fast screen transitions that make images appear sharper throughout.

One embodiment of the present disclosure aims to provide a ray tracing image quality control method according to camera movement, the method which enables increasing performance while maintaining ray tracing-based rendering image quality based on human cognitive factors, an image quality control apparatus performing the same, and a recording medium for storing the same.

Among embodiments, a ray tracing image quality control apparatus according to camera movement includes: an image sensitivity threshold setter configured to set an image sensitivity threshold based on a resolution of an image and a screen size; a current frame measurer configured to measure a camera movement speed through rendering of a current frame of the image; a previous frame measurer configured to measure Frame Per Second (FPS) through rendering of a previous frame of the image; an image sensitivity threshold adjuster configured to adjust the image sensitivity threshold based on the FPS and the camera movement speed; and a frame renderer configured to perform selective rendering of the current frame based on the adjusted image sensitivity threshold.

The image sensitivity threshold setter may set the image sensitivity threshold by determining weights between FPS sensitivity and image quality sensitivity based on the resolution and the screen size.

The image sensitivity threshold setter may increase the FPS sensitivity and decrease the image quality sensitivity as the resolution increases.

The image sensitivity threshold setter may increase the image quality sensitivity and decrease the FPS sensitivity as the screen size increases.

The current frame measurer may receive a screen movement input related to the image during a rendering process of the current frame to measure the camera movement speed.

The image sensitivity threshold adjuster may detect FPS of the previous frame, and in response to the detected FPS being smaller than a lower limit of the image sensitivity threshold, increase the image sensitivity threshold to increase the FPS of the current frame.

In response to the detected FPS greater than an upper limit of the image sensitivity threshold, the image sensitivity threshold adjuster may decrease the image sensitivity threshold to improve an image quality of the current frame.

In response to the detected FPS being equal to or greater than the lower limit of the image sensitivity threshold and equal to or smaller than the upper limit of the image sensitivity threshold, the image sensitivity threshold adjuster may detect the camera movement speed.

In response to the detected camera movement speed being smaller than a predetermined criterion, the image sensitivity threshold adjuster may decrease the image sensitivity threshold to improve image quality.

In response to the detected camera movement speed being equal to or greater than a predetermined criterion, the image sensitivity threshold adjuster may increase the image sensitivity threshold to improve a processing speed.

The frame renderer may render non-adjacent cells among a plurality of two-dimensional cells constituting the current frame, and then interpolate at least one intermediate cell between the non-adjacent cells.

The frame renderer may determine a distance between the non-adjacent cells and an accuracy of the interpolation based on the image sensitivity threshold.

Among embodiments, a ray tracing image quality control method according to a camera movement includes: an image sensitivity threshold setting step of setting an image sensitivity threshold based on a resolution of an image and screen size; a current frame measuring step of measuring a camera movement speed through rendering of a current frame of the image; a previous frame measuring step of measuring Frame Per Second (FPS) through rendering of a previous frame of the image; an image sensitivity threshold adjustment step of adjusting the image sensitivity threshold based on the FPS and the camera movement speed; and a frame rendering step of performing selective rendering of the current frame based on the adjusted image sensitivity threshold.

The image sensitivity threshold setting step may include setting the image sensitivity threshold by determining weights between FPS sensitivity and image quality sensitivity based on the resolution and the screen size.

The image sensitivity threshold adjustment step may include detecting FPS of the previous frame and, in response to the detected FPS being smaller than a lower limit of the image sensitivity threshold, increasing the image sensitivity threshold to increase the FPS of the current frame.

The image sensitivity threshold adjustment step may include, in response to the detected FPS exceeding an upper limit of the image sensitivity threshold, decreasing the image sensitivity threshold to increase image quality of the current frame.

The image sensitivity threshold adjusting step may include detecting the camera movement speed in response to the detected FPS being equal to or greater than the lower limit of the image sensitivity threshold and equal to or smaller than the upper limit of the image sensitivity threshold.

Among embodiments, a computer-readable recording medium may store a program for implementing a ray tracing image quality control method according to a camera movement.

The disclosed technology may have the following effects. However, since it does not mean that a specific embodiment must include all of the following effects or only the following effects, it should not be understood that the scope of the disclosed technology is limited thereto.

For a ray tracing image quality control method according to camera movement according to an embodiment of the present disclosure, an image quality control apparatus performing the same, and a recording medium storing the method, it is possible to control rendering performance and image quality by distinguishing between frames sensitive to image quality and frames sensitive to speed based on human cognitive factors and adjusting a threshold accordingly.

### BRIEF DESCRIPTION OF THE DRAWINGS

FIG. 1 is a diagram illustrating an embodiment of a ray tracing process.

FIG. 2 is a diagram illustrating an embodiment of a KD tree as an acceleration structure used in a ray tracing process.

FIG. 3 is a diagram describing a processing sequence of a ray tracing process.

FIG. 4 is a diagram describing an operation process of selective rendering.

FIG. 5 is a block diagram describing a functional configuration of a ray tracing image quality control apparatus according to the present disclosure.

FIG. 6 is a flowchart for explaining a ray tracing image quality control apparatus method according to the present disclosure.

FIG. 7 is a flowchart for explaining an embodiment of a ray tracing image quality control process according to the present disclosure.

### DETAILED DESCRIPTION

The description of the present disclosure is only an example for structural or functional explanation, and the scope of the present disclosure should not be construed as limited by the embodiments described herein. In other words, the embodiments can be modified in various ways and can have various forms, and the scope of the present disclosure should be understood to include equivalents that can realize the technical idea. In addition, the purpose or effect presented in the present disclosure does not mean that a specific embodiment should include all or only such effects, so the scope of the present disclosure should not be understood as limited thereby.

Meanwhile, the meaning of the terms described in the present specification should be understood as follows.

The terms such as “first,” “second,” etc. are intended to distinguish one component from another component, and the scope of the present disclosure should not be limited by these terms. For example, a first component may be named as a second component, and similarly, the second component may also be named as the first component.

When it is described that a component is “connected” to another component, it should be understood that one component may be directly connected to another component, but that other components may also exist between them. On the other hand, when it is described that a component is “directly connected” to another component, it should be understood that there is no other component between them. Meanwhile, other expressions that describe the relationship between components, such as “between” and “immediately between” or “neighboring” and “directly neighboring” should be interpreted similarly.

Singular expressions should be understood to include plural expressions unless the context clearly indicates otherwise, and terms such as “comprise or include” or “have” are intended to specify the existence of implemented features, numbers, steps, operations, components, parts, or combinations thereof, but should be understood as not precluding the possibility of the existence or addition of one or more other features, numbers, steps, operations, components, parts, or combinations thereof.

Identification symbols (for example, a, b, and c) for individual steps are used for the convenience of description. The identification symbols are not intended to describe an operation order of the steps. Therefore, unless otherwise explicitly indicated in the context of the description, the steps may be executed differently from the stated order. In other words, the respective steps may be performed in the same order as stated in the description, actually performed simultaneously, or performed in reverse order.

The present disclosure may be implemented in the form of program code in a computer-readable recording medium. A computer-readable recording medium includes all kinds of recording devices storing data that a computer system may read. Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner.

Unless defined otherwise, all the terms used in the present disclosure provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

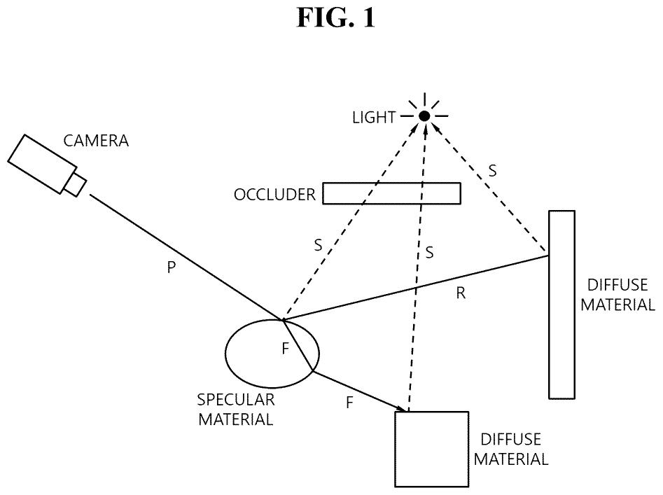

FIG. 1 is a diagram illustrating an embodiment of a ray tracing process.

Referring to FIG. 1, a ray tracing scheme performed by a ray tracing image quality control apparatus may correspond to a rendering scheme according to global illumination. This may mean that light reflected or refracted from another object also affects an image of a current object. As a result, since reflection, refraction, and shadow effects are naturally provided, realistic 3D images may be created.

The ray tracing image quality control apparatus may first generate a primary ray P from a camera position per pixel and perform a calculation to find an object that meets the ray. If an object which meets the ray has a property of reflection or refraction, the ray tracing image quality control apparatus may generate a reflection ray R for a reflection effect or a reflection ray F for a refraction ray at a position where the ray and the object meet, and also generate a shadow ray S in a light direction for a shadow effect.

In this case, if the shadow ray directed to the corresponding light position and a predetermined object meet, a shadow is generated, otherwise no shadow is generated. The reflection ray and the refraction ray are called secondary ray, and the ray tracing image quality control apparatus may perform a calculation to find an object that meets the ray for each ray. This process may be performed recursively by the ray tracing image quality control apparatus.

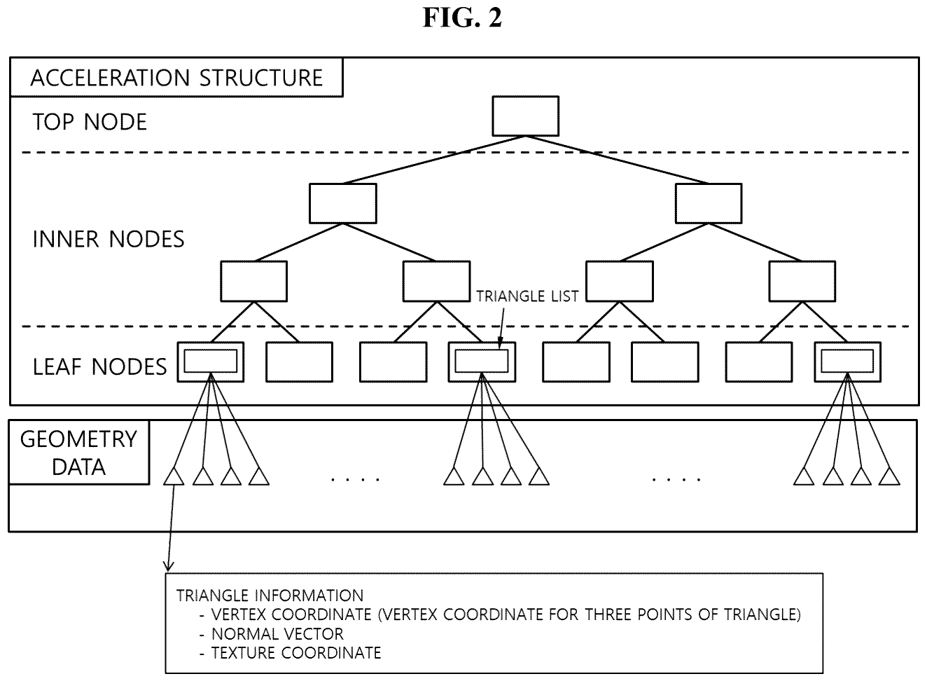

FIG. 2 is a diagram illustrating an embodiment of a KD tree as an acceleration structure used in a ray tracing process.

Referring to FIG. 2, in order to perform ray tracing, an acceleration structure (AS) such as a K-Dimensional (KD) tree or Bounding Volume Hierarchy (BVH) generated based on the entire geometry data (consisting of triangle coordinates) is requisitely required. Therefore, it is necessary to build the AS before performing the ray tracing. Since the acceleration structure building requires a large computation amount, the acceleration structure building may take a lot of time.

In FIG. 2, the overall configuration diagram of the KD-tree is described. The KD-tree may correspond to a binary tree having a hierarchical structure for the divided space. The KD-tree may be composed of an inner node (including a top node) and a leaf node, and the leaf node may correspond to a space containing an object that intersects with the corresponding node. That is, the KD-tree as a spatial partitioning tree may correspond to a kind of spatial partitioning structure.

On the other hand, the inner node may have a bounding box-based space region, and the space region may be divided into two regions and allocated to two lower nodes again. As a result, the inner node may consist of a split plane and sub-trees of two regions split through the split plane, and the leaf node may contain only a series of triangles. For example, the leaf node may include a triangle list for pointing at least one triangle information included in the geometric data, and the triangle information may include vertex coordinates, normal vectors, and/or texture coordinates for three points of the triangle. If the triangle information included in the geometric data is implemented as an array, the triangle list included in the leaf node may correspond to an array index.

On the other hand, a position p at which the space is divided may correspond to a point where the cost (the number of node visits, the number of counting whether the ray intersects with the triangle, etc.) to find a triangle that hits a random ray is minimal, and a currently most used method to find the corresponding position p may correspond to surface area heuristic (SAH).

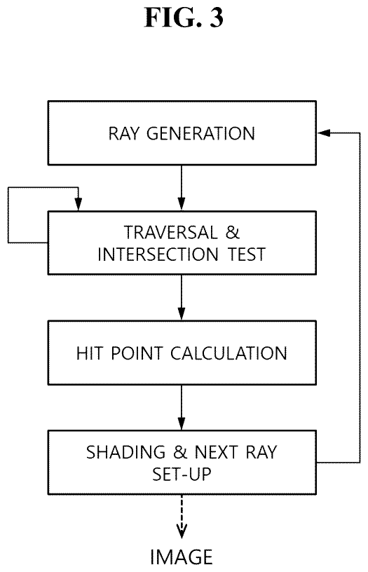

FIG. 3 is a diagram describing a processing sequence of a ray tracing process.

Referring to FIG. 3, the ray tracing process may largely include a ray generation step, a traversal & intersection test step, a hit point calculation step, and a shading & next ray set-up step.

First, in the ray generation step, a primary ray may be generated from a viewpoint position for each pixel. In the next step, the acceleration structure (AS) such as the KD-tree and the bounding volume hierarchy (BVH) is searched to find a leaf node that meets a ray. Here, the triangle information is stored in the leaf node.

In the next traversal & intersection test step, it may be tested whether all triangles in the meeting leaf node meet the ray. This process may be recursively performed until the triangle that meets the ray is found. Thereafter, in the hit point calculation step, the hit point may be calculated for the triangle that meets the ray.

In a shading step which is a next step, a color value on a ray-triangle hit point may be calculated. If it is necessary to generate the shadow ray due to illumination or the secondary ray due to a material of the hit triangle, the information is determined in the next ray set-up step and transmitted to the ray generation step. In the ray generation step, the shadow ray and the secondary ray may be generated based on this information.

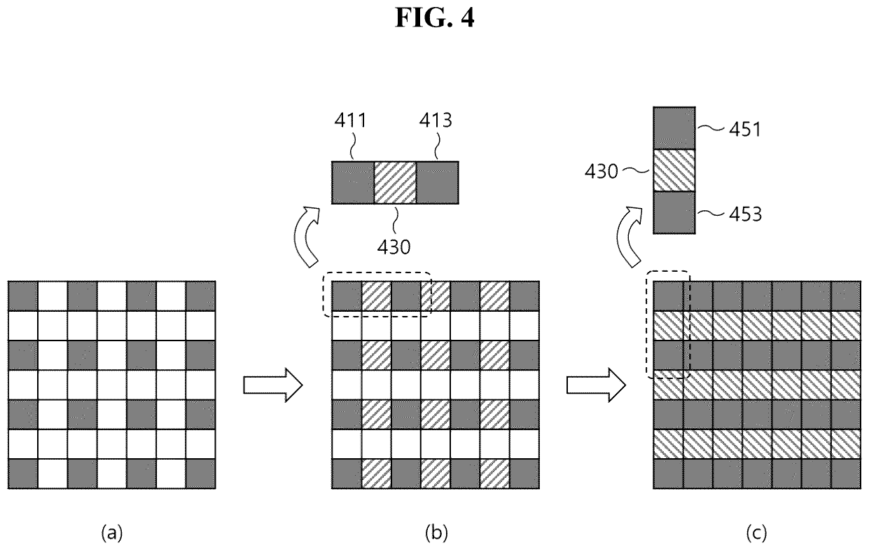

FIG. 4 is a diagram describing an operation process of selective rendering.

Referring to FIG. 4, in the case of rendering, sampling is generally performed for all pixels, and if the number of samples is smaller than the number of pixels, unsampled pixels may be accordingly generated by interpolating adjacent pixel values.

First, sampling may be performed by skipping x and y coordinates of the pixel one by one. This may be the same as a result of performing rendering at a low resolution. As a result, rendering is performed for the pixel at a gray position in (a) of FIG. 4 to generate the pixel at that position, and an unrendered pixel remains white. In a step of (b) of FIG. 4, after interpolation is performed using pixel data values 411 and 413 of a horizontal position for a pixel 430 that is not rendered, a pixel at the corresponding position may be generated.

After the step of (b) of FIG. 4 is completed, after interpolation is performed using pixel data values 451 and 453 of a vertical position for the pixel 430 that is not rendered, a pixel at the corresponding position may be generated. The embodiment of FIG. 4 may correspond to an example in which sampling is performed by skipping each of the x-coordinate and the y-coordinate one by one, but is not necessarily limited thereto, and may be performed by skipping each coordinate at a larger interval if necessary.

The selective rendering may be performed in a manner of determining whether to perform interpolation or sampling for an unsampled portion based on a threshold of color difference. For example, assuming that the threshold is set to 16, interpolation may be performed if the color difference between the sampled neighboring pixels is 16 or less, and sampling may be performed if the color difference exceeds 16. Therefore, if the threshold applied to the selective rendering is increased, rendering performance may increase while the image quality may decrease. By adjusting the threshold in this way, the rendering performance and the image quality may be adaptively selected.

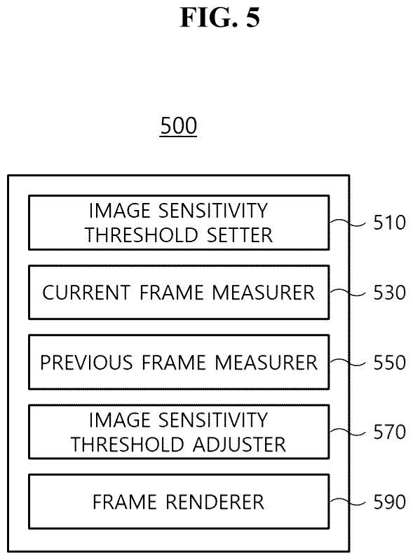

FIG. 5 is a block diagram describing a functional configuration of a ray tracing image quality control apparatus according to the present disclosure.

Referring to FIG. 5, a ray tracing image quality control apparatus 500 may include an image sensitivity threshold setter 510, a current frame measurer 530, a previous frame measurer 550, an image sensitivity threshold adjuster 570, a frame renderer 590, and a controller (not shown in FIG. 5).

The image sensitivity threshold setter 510 may set an image sensitivity threshold based on a resolution of an image and a screen size. The resolution of the image, which is the number of pixels or pixels that make up a frame, may indicate how precisely an object is expressed. The screen size may correspond to a size of a display screen on which the image is played. The image sensitivity threshold setter 510 may determine an image sensitivity threshold, which affects overall rendering quality, based on static setting conditions before rendering is performed through ray tracing. In other words, the image sensitivity threshold may be used as a criterion for selectively performing a specific operation in a process of performing ray tracing.

In one embodiment, the image sensitivity threshold setter 510 may set an image sensitivity threshold by determining weights between FPS sensitivity and image quality sensitivity based on a resolution and a screen size. That is, the image sensitivity threshold setter 510 may control a sensitivity threshold for an entire area within a frame. Here, the image quality sensitivity may correspond to a degree of sensitivity to change in image quality, and FPS sensitivity may correspond to a degree of sensitivity to change in FPS. In other words, if the sensitivity is higher, the degree of visual perception of an image experienced by humans may also increase due to change in image quality or FPS. The image sensitivity threshold setter 510 may independently determine weights for FPS sensitivity and image quality sensitivity based on the resolution and screen size, and the image sensitivity threshold may be determined as a result of applying the respective weights.

More specifically, in one embodiment, as resolution increases, the image sensitivity threshold setter 510 may increase FPS sensitivity and decrease image quality sensitivity. In another embodiment, as the screen size increases, the image sensitivity threshold setter 510 may increase image quality sensitivity and decrease FPS sensitivity. In general, viewers may be more sensitive to image quality in a case of a large screen, while more sensitive to FPS in a case of a small screen. In addition, if the resolution is high, the viewers may be more sensitive to FPS, and if the resolution is low, the viewers may be more sensitive to image quality.

Human visual processing is excessively focused on the center of the field of view, so the resolution in the central part of the eye may be significantly higher. Therefore, Therefore, in the case of a larger screen, the viewers may be more sensitive to image quality due to a shorter distance from a center of the screen to cells, while with a smaller screen at the same viewing distance, the viewers may be more sensitive to FPS than image quality because the distance between the center and the cells is relatively farther.

As a result, the screen size and the resolution may form a trade-off relationship in setting an image sensitivity threshold. The image sensitivity threshold setter 510 may set an image sensitivity threshold based on the screen size and resolution in a pre-processing step. For example, in case of, a smart phone where the screen size is small with high resolution, the image sensitivity threshold may be set relatively high. Conversely, on a TV with a large screen, if the resolution is low, a low image sensitivity threshold may be set, and if the resolution is high, a high or medium image sensitivity threshold may be set.

The current frame measurer 530 may measure a camera movement speed through rendering of a current frame of an image. That is, with respect to the current frame, the current frame measurer 530 may perform rendering on all pixels in a screen area based on the resolution. The current frame measurer 530 may measure a camera movement speed based on changes in an image due to a camera movement while performing rendering for a given frame time. For example, if a specific object is present in the image, the current frame measurer 530 may track a positional change of the specific object during a rendering process and measure a camera movement speed based on an amount of the positional change during a frame time.

In one embodiment, the current frame measurer 530 may receive a screen movement input related to an image during a rendering process of a current frame to measure a camera movement speed. For example, the current frame measurer 530 may calculate a camera movement speed by measuring absolute values or relative changes of input values from a joystick, a mouse, keyboard direction keys, an HMD or smartphone sensor, a VA/AR motion sensor, or a simulator controller.

The previous frame measurer 550 may measure an FPS (Frame Per Second) through rendering of a previous frame of an image. While the current frame measurer 530 measures relevant information during a rendering process of a current frame, the previous frame measurer 550 may measure a predetermined performance metric during a rendering process of a previous frame. For example, the previous frame measurer 550 may measure rendering FPS as a performance metric related to a frame processing speed.

The image sensitivity threshold adjuster 570 may adjust an image sensitivity threshold based on FPS and a camera movement speed. The image sensitivity threshold adjuster 570 may adjust an image sensitivity threshold based on an operating environment of the ray tracing, thereby dynamically controlling an image quality provided to a user.

In one embodiment, the image sensitivity threshold adjuster 570 may detect FPS of a previous frame, and in response to the detected FPS of the previous frame being smaller than a lower limit of an image sensitivity threshold, increase the image sensitivity threshold to increase FPS of the current frame. If the FPS of the previous frame is smaller than the lower limit of the image sensitivity threshold, rendering performance of the current frame may also be low, so the image sensitivity threshold controller 570 may increase the image sensitivity threshold to improve the rendering performance. That is, if the image sensitivity threshold increases, the number of ray tracing operations performed within the current frame may decrease, resulting in an increase in the processing speed of the current frame and consequently, an increase in FPS.

In one embodiment, if the detected FPS is greater than an upper limit of the image sensitivity threshold, the image sensitivity threshold adjuster 570 may decrease the image sensitivity threshold to improve the image quality of the current frame. If the FPS of the previous frame is greater than the upper limit of the image sensitivity threshold, the rendering performance of the current frame may be high, so the image sensitivity threshold adjuster 570 may decrease the image sensitivity threshold to lower the rendering performance. In other words, if the image sensitivity threshold decreases, the number of ray tracing operations performed within the current frame may increase, resulting in an increase in sampling quality of the current frame and consequently, an increase in image quality of the frame.

In one embodiment, if the detected FPS is equal to or greater than the lower limit of the image sensitivity threshold and equal to or smaller than the upper limit of the image sensitivity threshold, the image sensitivity threshold adjuster 570 may detect a camera movement speed. If the rendering FPS of the previous frame is within a predetermined range, the image sensitivity threshold adjuster 570 may adjust the image sensitivity threshold based on a camera movement speed and may additionally detect the camera movement speed during rendering of the current frame.

In one embodiment, if the detected camera movement speed is smaller than a predetermined criterion, the image sensitivity threshold adjuster 570 may decrease the image sensitivity threshold to improve the image quality. If the camera movement speed is low, the screen transition is slow, increasing sensitivity to image quality over a processing speed. As a result, ray tracing is performed on more pixels, increasing the image quality of the current frame.

In one embodiment, if the detected camera movement speed is equal to or greater than a predetermined criterion, the image sensitivity threshold adjuster 570 may increase the image sensitivity threshold to improve a processing speed. If the camera movement speed is high, the screen transition is fast, increasing sensitivity to a processing speed over image quality. In addition, if the camera movement speed is high, the rendering burden on the current frame may be high, and the increase in the image sensitivity threshold may reduce the burden of ray tracing. As a result, ray tracing may be performed on a relatively smaller number of pixels, increasing the processing speed of the current frame.

The frame renderer 590 may perform selective rendering on the current frame based on the adjusted image sensitivity threshold. In other words, the frame renderer 590 may perform selective rendering by determining, based on the image sensitivity threshold and the result of rendering the current frame, whether to render or not render unrendered pixels present between rendered pixels.

For example, the frame renderer 590 may determine whether to render pixels left unrendered after low-resolution rendering of the current frame by comparing color difference between rendered pixels vertically or horizontally adjacent to the unrendered pixels with an image sensitivity threshold adjusted by the image sensitivity threshold adjuster 570. If it is determined to render the unrendered pixels, ray tracing of the corresponding pixels may be performed, and if not, an interpolation algorithm may be applied to determine color of the corresponding pixels.

In one embodiment, the frame renderer 590 may render non-adjacent cells among a plurality of two-dimensional cells constituting the current frame, and then interpolate at least one intermediate cell between the non-adjacent cells. For example, the frame renderer 590 may perform rendering on each odd-numbered cell based on the X and Y axes of the current frame, and apply an interpolation algorithm based on the colors of the odd-numbered cells to calculate color values for the even-numbered cells. A result of rendering the odd-numbered cells may be the same as the result of the low-resolution rendering Meanwhile, here, the two-dimensional cells may be in a one-to-one correspondence with the pixels of the frame. In addition, the two-dimensional cells may be in one-to-one correspondence with pixel groups defined for the frame, and the pixel groups may correspond to sets of adjacent pixels along the x-axis and y-axis of the frame. For example, if a current frame is of size 10×10, the number of two-dimensional cells in one-to-one correspondence with the respective pixels may be a total of 10×10=100. That is, the two-dimensional cells may be of size 10×10. In addition, if pixel groups in size of 2×2 are defined, the number of two-dimensional cells in one-to-one correspondence with the respective pixel groups may be a total of (10/2)×(10/2)=25. That is, the two-dimensional cells may have a size 5×5.

In one embodiment, the frame renderer 590 may determine a distance between non-adjacent cells and an accuracy of interpolation based on an image sensitivity threshold. If the image sensitivity threshold is higher, the frequency of interpolation in the selective rendering process may increase, and the frame renderer 590 may compensate for the quality degradation due to increased interpolation by reducing the distance between non-adjacent cells or increasing the accuracy of interpolation.

Conversely, if the image sensitivity threshold is lower, the frequency of interpolation may decrease and the frequency of ray tracing may increase, and the frame renderer 590 may increase the distance between non-adjacent cells or lowering the accuracy of interpolation to compensate for a speed reduction due to increased ray tracing.

In one embodiment, the frame renderer 590 may adjust the distance between non-adjacent cells based on the size of a pixel group. For example, if a current frame is of size 10×10 and each pixel group of size 2×2 is defined, two-dimensional cells corresponding to each pixel group may be defined as a total of 5×5=25, and the distance between non-adjacent cells may be 2, which is the size of each pixel group. Therefore, the frame renderer 590 may adjust the distance between non-adjacent cells by increasing or decreasing the size of each pixel group.

The controller (not shown in FIG. 5) may control the overall operation of the ray tracing image quality control apparatus 500 and manage the control flow or data flow between the image sensitivity threshold setter 510, the current frame measurer 530, the previous frame measurer 550, the image sensitivity threshold adjuster 570, and the frame renderer 590.

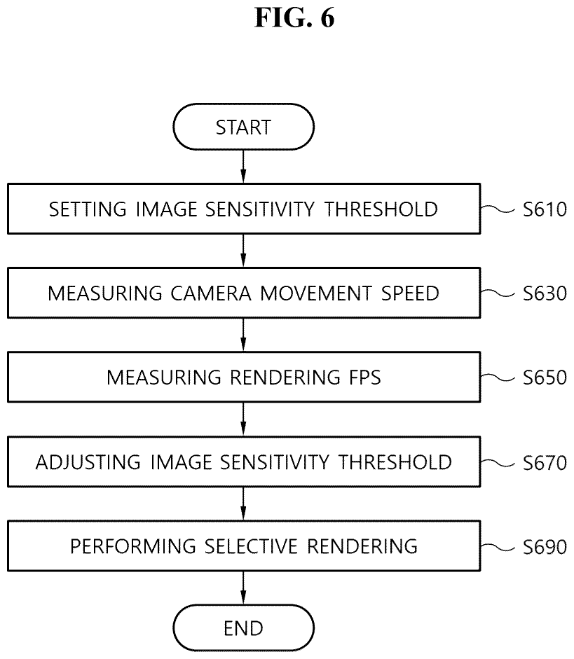

FIG. 6 is a flowchart for explaining a ray tracing image quality control apparatus method according to the present disclosure.

Referring to FIG. 6, the ray tracing image quality control apparatus 500 may set an image sensitivity threshold based on a resolution of an image and a screen size using an image sensitivity threshold setter 510 (step S610). The ray tracing image quality control apparatus 500 may measure a camera movement speed through rendering of a current frame of the image using the current frame measurer 530 (step S630).

In addition, the ray tracing image quality control apparatus 500 may measure FPS (Frame Per Second) through rendering of a previous frame of the image using the previous frame measurer 550 (step S650). The ray tracing image quality control apparatus 500 may adjust the image sensitivity threshold based on the FPS and the camera movement speed using the image sensitivity threshold adjuster 570 (step S670).

In addition, the ray tracing image quality control apparatus 500 may perform selective rendering of the current frame based on the image sensitivity threshold adjusted using the frame renderer 590 (step S690).

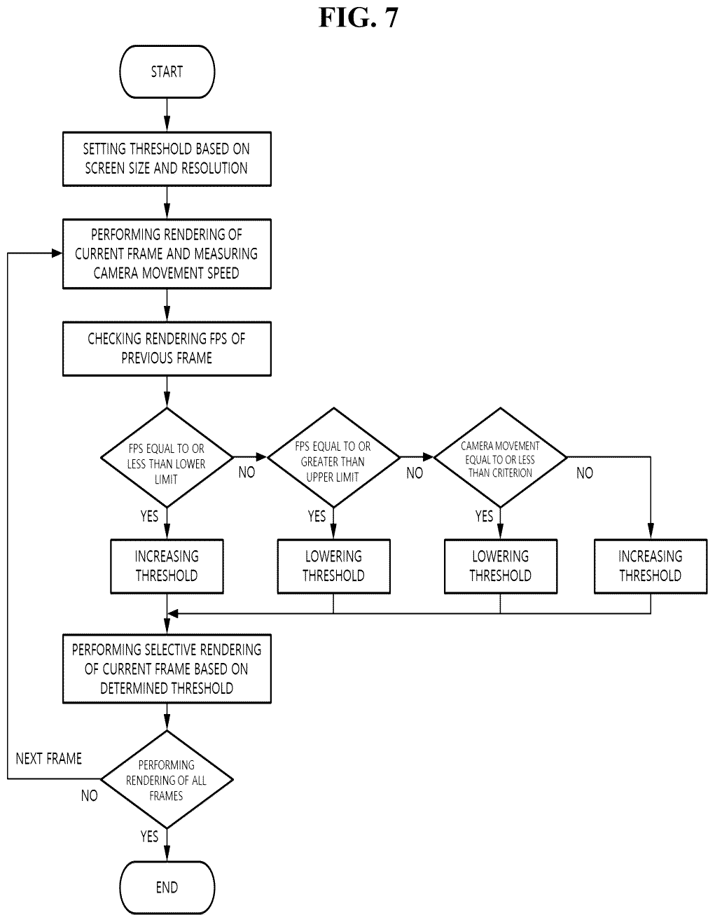

FIG. 7 is a flowchart for explaining an embodiment of a ray tracing image quality control process according to the present disclosure.

Referring to FIG. 7, a ray tracing image quality control apparatus 500 may set a threshold based on a screen size and a resolution. The ray tracing image quality control apparatus 500 may perform low-resolution rendering of the current frame and measure a camera movement speed. The ray tracing picture quality control apparatus 500 may check rendering FPS of a previous frame.

If the measured FPS is equal to or smaller than a lower limit of a set threshold, the ray tracing image quality control apparatus 500 may increase the threshold. If the measured FPS is equal to or greater than an upper limit of the set threshold, the ray tracing image quality control apparatus 500 may lower the threshold. If the measured FPS is between the lower limit and upper limit of the set threshold, the ray tracing image quality control apparatus 500 may adjust the threshold based on camera movement. That is, when the camera movement is equal to or smaller than a reference value, the ray tracing image quality control apparatus 500 may lower the threshold, and when the camera movement is above the reference value, the ray tracing image quality control apparatus 500 may increase the threshold.

Once the threshold is determined, the ray tracing image quality control apparatus 500 may perform selective rendering of the current frame. The selective rendering may be performed by selectively applying a rendering method to unrendered pixels within a frame based on a result of comparing a color difference of rendered pixels adjacent to the unrendered pixels on both sides with the adjusted threshold. The ray tracing image quality control apparatus 500 may repeatedly perform dynamic adjustment of the threshold based on the camera movement speed and FPS for each frame and selective rendering until rendering is completed for all frames.

Meanwhile, the ray tracing image quality control apparatus 500 according to the present disclosure may improve rendering performance while maintaining image quality, by distinguishing between frames sensitive to image quality and frames sensitive to speed based on human cognitive factors and adjusting a threshold accordingly, and to this end, there may be disclosed a method for dynamically adjusting a threshold applied in a selective rendering process based on a camera movement speed and rendering FPS.

Although an exemplary embodiment of the present disclosure has been described for illustrative purposes, those skilled in the art will appreciate that various modifications, and substitutions are possible, without departing from the scope and spirit of the present disclosure as disclosed in the accompanying claims.

[DESCRIPTION OF REFERENCE NUMERALS]

| | |
|---|---|
| 411, 413: pixel data value of | |
| horizontal position | |
| 430: unrendered pixel | |
| 451, 453: pixel data value of | |
| vertical position | |
| 500: ray tracing image quality | |
| control apparatus | |
| 510: Image sensitivity threshold | 530: current frame measurer |
| setter | |
| 550: previous frame measurer | 570: image sensitivity |
| | threshold adjuster |
| 590: frame renderer | |

1. A ray tracing image quality control apparatus according to camera movement, the apparatus comprising:
an image sensitivity threshold setter configured to set an image sensitivity threshold based on a resolution of an image and a screen size;
a current frame measurer configured to measure a camera movement speed through rendering of a current frame of the image;
a previous frame measurer configured to measure Frame Per Second (FPS) through rendering of a previous frame of the image;
an image sensitivity threshold adjuster configured to adjust the image sensitivity threshold based on the FPS and the camera movement speed; and
a frame renderer configured to perform selective rendering of the current frame based on the adjusted image sensitivity threshold.

2. The apparatus of claim 1, wherein the image sensitivity threshold setter sets the image sensitivity threshold by determining weights between FPS sensitivity and image quality sensitivity based on the resolution and the screen size.

3. The apparatus of claim 2, wherein the image sensitivity threshold setter increases the FPS sensitivity and decreases the image quality sensitivity as the resolution increases.

4. The apparatus of claim 3, wherein the image sensitivity threshold setter increases the image quality sensitivity and decreases the FPS sensitivity as the screen size increases.

5. The apparatus of claim 1, wherein the current frame measurer receives a screen movement input related to the image during a rendering process of the current frame to measure the camera movement speed.

6. The apparatus of claim 1, wherein the image sensitivity threshold adjuster detects FPS of the previous frame, and in response to the detected FPS being smaller than a lower limit of the image sensitivity threshold, increases the image sensitivity threshold to increase the FPS of the current frame.

7. The method of claim 6, wherein, in response to the detected FPS greater than an upper limit of the image sensitivity threshold, the image sensitivity threshold adjuster decreases the image sensitivity threshold to improve an image quality of the current frame.

8. The apparatus of claim 7, wherein, in response to the detected FPS being equal to or greater than the lower limit of the image sensitivity threshold and equal to or smaller than the upper limit of the image sensitivity threshold, the image sensitivity threshold adjuster detects the camera movement speed.

9. The apparatus of claim 8, wherein, in response to the detected camera movement speed being smaller than a predetermined criterion, the image sensitivity threshold adjuster decreases the image sensitivity threshold to improve image quality.

10. The apparatus of claim 8, wherein, in response to the detected camera movement speed being equal to or greater than a predetermined criterion, the image sensitivity threshold adjuster increases the image sensitivity threshold to improve a processing speed.

11. The apparatus of claim 1, wherein the frame renderer renders non-adjacent cells among a plurality of two-dimensional cells constituting the current frame, and then interpolates at least one intermediate cell between the non-adjacent cells.

12. The apparatus of claim 11, wherein the frame renderer determines a distance between the non-adjacent cells and an accuracy of the interpolation based on the image sensitivity threshold.

13. A ray tracing image quality control method according to camera movement, the method comprising:
an image sensitivity threshold setting step of setting an image sensitivity threshold based on a resolution of an image and screen size;
a current frame measuring step of measuring a camera movement speed through rendering of a current frame of the image;
a previous frame measuring step of measuring Frame Per Second (FPS) through rendering of a previous frame of the image;
an image sensitivity threshold adjustment step of adjusting the image sensitivity threshold based on the FPS and the camera movement speed; and
a frame rendering step of performing selective rendering of the current frame based on the adjusted image sensitivity threshold.

14. The method of claim 13, wherein the image sensitivity threshold setting step comprises setting the image sensitivity threshold by determining weights between FPS sensitivity and image quality sensitivity based on the resolution and the screen size.

15. The method of claim 13, wherein the image sensitivity threshold adjustment step comprises detecting FPS of the previous frame and, in response to the detected FPS being smaller than a lower limit of the image sensitivity threshold, increasing the image sensitivity threshold to increase the FPS of the current frame.

16. The method of claim 15, wherein the image sensitivity threshold adjustment step comprises, in response to the detected FPS exceeding an upper limit of the image sensitivity threshold, decreasing the image sensitivity threshold to increase image quality of the current frame.

17. The method of claim 16, wherein the image sensitivity threshold adjusting step comprises detecting the camera movement speed in response to the detected FPS being equal to or greater than the lower limit of the image sensitivity threshold and equal to or smaller than the upper limit of the image sensitivity threshold.

18. A computer readable recording medium having recorded thereon a computer program for implementing the method according to claim 13.
